(19) United States
(12) Patent Application Publication
(10) Pub. No.: US 2026/0348132 A1
(43) Pub. Date: Nov. 5, 2026

(54) WORK MACHINE AND METHOD FOR CONTROLLING WORK MACHINE

(71) Applicant: KOMATSU LTD., Tokyo (JP)

(72) Inventor: Mitsuhito NAKATANI, Tokyo (JP)

(21) Appl. No.: 19/117,835

(22) PCT Filed: Sep. 15, 2023
(86) PCT No.: PCT/JP2023/033666

§ 371 Date: Apr. 2, 2025

(30) Foreign Application Priority Data
Oct. 18, 2022 (JP) 2022-166784

(51) Int. Cl. E02F 9/22; E02F 3/43

(52) U.S. Cl. CPC E02F 9/2246; E02F 3/431

(57) ABSTRACT

A work machine includes a vehicle body, an engine, a travel device, a work implement, a sensor, and a controller. The sensor detects state data indicating operating states of the travel device and the work implement. The controller acquires the state data. The controller determines a work stage of the work machine based on the operating states of the travel device and the work implement. The controller controls the output of the engine in a first control mode when the work stage is determined as being predetermined work other than excavation. The controller controls the output of the engine in a second control mode when the work stage is determined as being excavation. The controller reduces the upper limit of the output of the engine in the second control mode to be lower than in the first control mode.

### CROSS-REFERENCE TO RELATED APPLICATIONS

This application is a U.S. National stage application of International Application No. PCT/JP2023/033666, filed on Sep. 15, 2023. This U.S. National stage application claims priority under 35 U.S.C. § 119(a) to Japanese Patent Application No. 2022-166784, filed in Japan on Oct. 18, 2022, the entire contents of which are hereby incorporated herein by reference.

### BACKGROUND

### Technical Field

The present disclosure relates to a work machine and a method for controlling the work machine.

### Background Information

Among work machines such as construction machines, there is a work machine that detects the work stage currently being performed and automatically controls the output of the engine. For example, in the work machine in International Publication WO 2005-024208, a controller determines whether the work machine is performing excavation or hill climbing travel. When the work machine is performing excavation or hill climbing travel, the engine is operated at high output, and when other work is being performed, the engine is operated at low output.

### SUMMARY

In the abovementioned work machine, the engine output is increased in a work stage in which the load on the work machine is high such as excavation or hill climbing travel. Conversely, the engine output is limited during a work stage in which the load on the work machine is low.

Recently, work machines have appeared with which the engine output is increased in order to reduce the fuel consumption of the work machine. Engines in which the output is increased are made to have the same output as conventional engines at low engine rotation speeds. Consequently, fuel consumption of the work machine can be improved. However, in work machines with increased engine output, the engine is operated at an excessively high output with respect to the load on the work machine and therefore the fuel consumption may actually become worse. An object of the present disclosure is to improve fuel consumption in a work machine by controlling the engine at a suitable output in accordance with the load on the work machine.

A work machine according to a first embodiment of the present disclosure includes a vehicle body, an engine, a travel device, a work implement, a sensor, and a controller. The engine is mounted to the vehicle body. The travel device is mounted to the vehicle body. The travel device causes the vehicle body to travel by being driven with driving power from the engine. The work implement is movably supported by the vehicle body. The work implement operates with the driving power from the engine. The sensor detects state data indicating operating states of the travel device and the work implement. The controller controls the engine, the travel device, and the work implement.

The controller acquires the state data. The controller determines a work stage of the work machine based on the operating states of the travel device and the work implement. The controller controls the output of the engine in a first control mode when the work stage is determined as being predetermined work other than excavation. The controller controls the output of the engine in a second control mode when the work stage is determined as being excavation. The controller reduces the upper limit of the output of the engine in the second control mode to be lower than that of the first control mode.

A method according to another embodiment of the present invention is a method for controlling a work machine. The work machine includes a vehicle body, an engine, a travel device, a work implement, a sensor, and a controller. The engine is mounted to the vehicle body. The travel device is mounted to the vehicle body. The travel device causes the vehicle body to travel by being driven with driving power from the engine. The work implement is movably supported by the vehicle body. The work implement operates with driving power from the engine. The method includes acquiring state data that indicates the operating states of the travel device and the work implement, determining a work stage of the work machine based on the operating states of the travel device and the work implement, controlling the output of the engine in a first control mode when the work stage is determined as being predetermined work other than excavation, controlling the output of the engine in a second control mode when the work stage is determined as being excavation, and reducing the upper limit of the output of the engine in the second control mode to be lower than that of the first control mode.

According to the present disclosure, when the work stage is determined as being excavation, the output of the engine is controlled in the second control mode. The upper limit of the output of the engine in the second control mode is controlled to be lower than that of the first control mode. Consequently, the engine is controlled with a suitable output that corresponds to the load on the work machine during excavation work whereby fuel consumption is improved.

### BRIEF DESCRIPTION OF DRAWINGS

FIG. 1 is a side view of a work machine according to an embodiment.

FIG. 2 is a block diagram illustrating a configuration of the work machine.

FIG. 3 is a block diagram illustrating a process for determining a target output torque of the engine.

FIG. 4 illustrates a torque distribution for a required torque for the work implement and a required torque for the transmission.

FIG. 5 is a flow chart illustrating a process of an output limit control of the engine.

FIG. 6 illustrates a first torque upper limit and a second torque upper limit of the target output torque of the engine.

FIG. 7 is a timing chart illustrating upper limits of the output of the engine modified in accordance with the work stage.

### DETAILED DESCRIPTION OF EMBODIMENT(S)

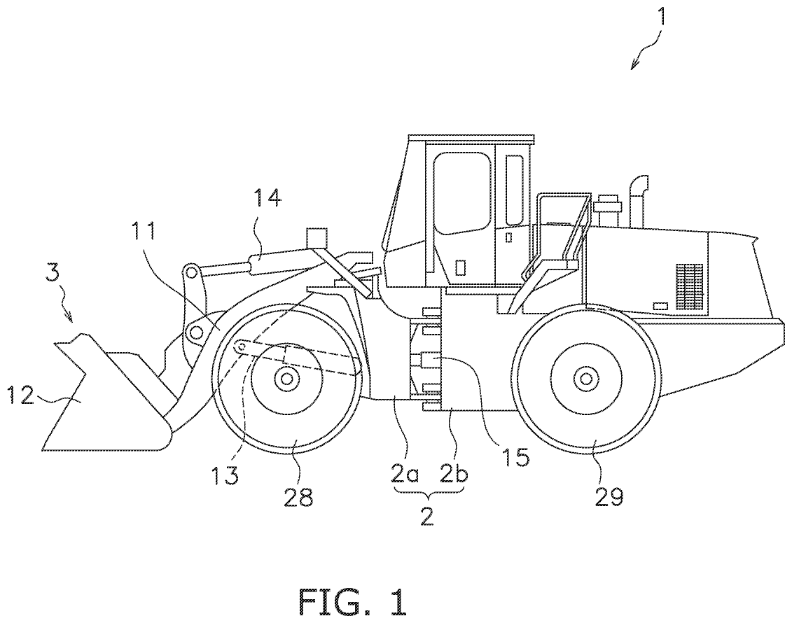

An embodiment of the present disclosure will be explained in detail with reference to the figures. FIG. 1 is a side view of a work machine 1 according to the embodiment. The work machine 1 according to the present embodiment is a wheel loader. As illustrated in FIG. 1, the work machine 1 includes a vehicle body 2 and a work implement 3.

The vehicle body 2 includes a front vehicle body 2a and a rear vehicle body 2b. The rear vehicle body 2b is connected to be swingable to the left and right with respect to the front vehicle body 2a. The front vehicle body 2a and the rear vehicle body 2b are coupled by a hydraulic cylinder 15. The hydraulic cylinder 15 extends and contracts whereby the front vehicle body 2a turns to the left and right with respect to the rear vehicle body 2b.

The work implement 3 is used for work such as excavating, earth moving, or soil unloading. The work implement 3 is movably attached to the front vehicle body 2a. The work implement 3 includes a boom 11, a bucket 12, and hydraulic cylinders 13 and 14. The hydraulic cylinders 13 and 14 extend and contract thereby moving the boom 11 and the bucket 12.

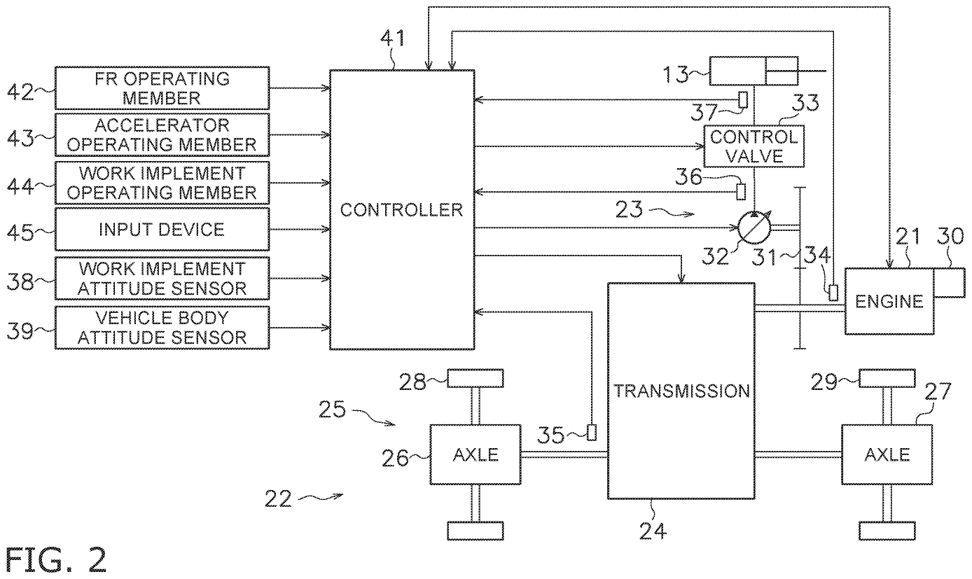

FIG. 2 is a block diagram illustrating a configuration of the work machine 1. As illustrated in FIG. 2, the work machine 1 includes an engine 21, a first drive system 22, and a second drive system 23. The engine 21 is, for example, a diesel engine. The engine 21 includes a fuel injection device 30. The fuel injection device 30 adjusts the amount of fuel injected into the cylinders of the engine 21 thereby controlling the output of the engine 21.

The first drive system 22 includes a transmission 24 and a travel device 25. The transmission 24 is connected to the engine 21. The transmission 24 transmits the driving power from the engine 21 to the travel device 25. For example, the transmission 24 is a hydraulic mechanical transmission (HMT). The HMT includes a planetary gear mechanism and a hydraulic pump/motor. The HMT is configured to modify the transmission gear ratio to stageless by controlling the capacity of the hydraulic pump/motor.

However, the transmission 24 may be another type of transmission such as an electric mechanical transmission (EMT) or a hydro-static transmission (HST). Alternatively, the transmission 24 may be a transmission having a torque converter and a plurality of speed change gears.

The travel device 25 is mounted to the vehicle body 2 and causes the vehicle body to travel by being driven with driving power from the engine 21. The travel device 25 includes axles 26 and 27, front wheels 28, and rear wheels 29. The axles 26 and 27 are connected to the transmission 24. The front wheels 28 are provided to the front vehicle body 2a. The rear wheels 29 are provided to the rear vehicle body 2b. The axle 26 transmits the driving power from the transmission 24 to the front wheels 28. The axle 27 transmits the driving power from the transmission 24 to the rear wheels 29.

The second drive system 23 includes a power take-off (PTO) 31, a hydraulic pump 32, and a control valve 33. The PTO 31 distributes the driving power of the engine 21 between the transmission 24 and the hydraulic pump 32. Only one hydraulic pump 32 is illustrated in FIG. 2. However, two or more hydraulic pumps may be connected to the engine 21 via the PTO 31.

The hydraulic pump 32 is connected to the engine 21 via the PTO 31. The hydraulic pump 32 is driven by the engine 21 and discharges hydraulic fluid. The hydraulic fluid discharged from the hydraulic pump 31 is supplied to the abovementioned hydraulic cylinders 13 to 15. Only the hydraulic cylinder 13 is depicted in FIG. 2 and the other hydraulic cylinders 14 and 15 are omitted.

The control valve 33 controls the flow rate of the hydraulic fluid supplied from the hydraulic pump 32 to the hydraulic cylinders 13 to 15. The control valve 33 is, for example, an electromagnetic proportional control valve and is controlled in accordance with input electrical signals. Alternatively, the control valve 33 may be a pressure proportional control valve and may be controlled in accordance with input pilot pressures.

The work machine 1 includes an engine sensor 34 and a vehicle speed sensor 35. The engine sensor 34 detects the engine rotation speed. The vehicle speed sensor 35 detects the output rotation speed of the travel device 25. The output rotation speed of the travel device 25 corresponds to the vehicle speed of the work machine 1. The output rotation speed of the travel device 25 is, for example, the rotation speed of the output shaft of the transmission 24. However, the output rotation speed may be the rotation speed of another rotating element that is inside the transmission 24 or that is positioned downstream of the transmission 24.

The work machine 1 includes a pump pressure sensor 36 and a cylinder pressure sensor 37. The pump pressure sensor 36 detects the discharge pressure of the hydraulic pump 32. The cylinder pressure sensor 37 detects the boom bottom pressure of the hydraulic cylinder 13. The boom bottom pressure is the hydraulic pressure supplied to the hydraulic cylinder 13 when the hydraulic cylinder 13 is extended.

The work machine 1 includes a work implement attitude sensor 38 and a vehicle body attitude sensor 39. The work implement attitude sensor 38 detects the attitude of the work implement 3. The attitude of the work implement 3 includes, for example, the boom angle. The boom angle is the angle of the boom 11 with respect to the horizontal direction. The work implement attitude sensor 38 is, for example, an angle sensor attached to the boom 11. Alternatively, the work implement attitude sensor 38 may be a stroke sensor that detects the stroke amount of the hydraulic cylinder 13. In this case, the boom angle may be calculated from the stroke amount of the hydraulic cylinder 13 detected by the stroke sensor.

The vehicle body attitude sensor 39 detects the attitude of the vehicle body 2. The attitude of the vehicle body 2 includes, for example, the pitch angle and the roll angle of the vehicle body 2. The vehicle body attitude sensor 39 is, for example, an inertial measurement unit (IMU). Alternatively, the vehicle body attitude sensor 39 may be a sensor other than an IMU.

The work vehicle 1 includes a controller 41. The controller 41 includes a processor such as a central processing unit (CPU), and a storage device such as a RAM or a ROM. The controller 41 may include an auxiliary storage device such as a hard disk or a solid state drive (SSD). The controller 41 stores programs and data for controlling the work machine 1. The controller 41 executes processes for controlling the work machine 1 in accordance with the stored programs and data.

The controller 41 receives a signal indicating the engine rotation speed from the engine sensor 34. The controller 41 receives a signal indicating the output rotation speed from the vehicle speed sensor 35. The controller 41 receives a signal indicating the discharge pressure of the hydraulic pump 32 from the pump pressure sensor 36. The controller 41 receives a signal indicating the boom bottom pressure from the cylinder pressure sensor 37. The controller 41 receives a signal indicating the attitude of the work implement 3 from the work implement attitude sensor 38. The controller 41 receives a signal indicating the attitude of the vehicle body 2 from the vehicle body attitude sensor 39.

The controller 41 controls the output of the engine by transmitting an instruction signal to the engine 21. The controller 41 switches between the forward travel gear and the rearward travel gear of the transmission 24 by transmitting an instruction signal to the transmission 24. The controller 41 controls the transmission gear ratio of the transmission 24 by transmitting an instruction signal to the transmission 24. The controller 41 controls the work implement 3 by transmitting instruction signals to the hydraulic pump 32 and the control valve 33.

The work machine 1 includes an FR operating member 42, an accelerator operating member 43, a work implement operating member 44, and an input device 45. The FR operating member 42 is operable by the operator for switching between forward travel and reverse travel of the work machine 1. The FR operating member 42 is operable in a forward travel position and a reverse travel position from a neutral position. The FR operating member 42 is, for example, a lever. However, the FR operating member 42 may be another member such as a switch or a pedal.

The accelerator operating member 43 is operable by the operator for controlling the vehicle speed of the work machine 1. The accelerator operating member 43 is, for example, a pedal. However, the accelerator operating member 43 may be another member such as a lever or a switch. The work implement operating member 44 is operable by the operator for controlling the work implement 3. The work implement operating member 44 is, for example, a lever. However, the work implement operating member 44 may be another member such as a switch or a pedal.

The input device 45 is operable by the operator for setting the control of the work machine 1. For example, the input device 45 sets the work machine 1 in accordance with an operation by the operator. The input device 45 is, for example, a touchscreen. However, the input device 45 may include another member such as a mechanical switch.

The controller 41 receives a signal indicating the operating position of the FR operating member 42 from the FR operating member 42. The controller 41 switches between the forward travel gear and the rearward travel gear of the transmission 24 in accordance with signal from the FR operating member 42. The controller 41 receives a signal indicating an accelerator operating amount from the accelerator operating member 43. The accelerator operating amount is the operating amount of the accelerator operating member 43. The controller 41 receives a signal indicating a work implement operating amount from the work implement operating member 44. The work implement operating amount is the operating amount of the work implement operating member 44. The controller 41 receives a signal indicating the setting of the work machine 1 from the input device 45.

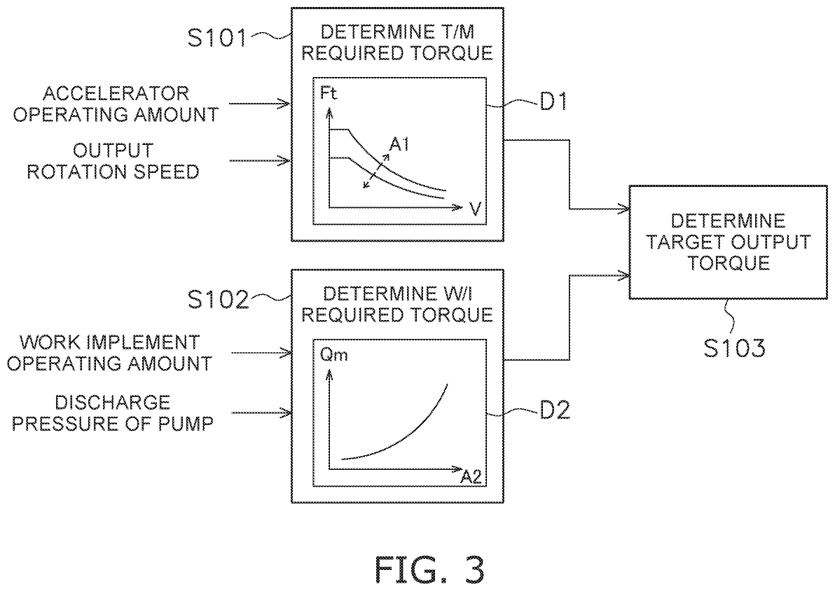

A process for controlling the engine 21 executed by the controller 41 is explained hereinbelow. FIG. 3 is a block diagram illustrating a process for controlling the engine 21. As illustrated in FIG. 3, in step S101, the controller 41 determines a required torque (referred to below as T/M required torque) of the transmission 24. The T/M required torque is the output torque of the engine 21 required for causing the work machine 1 to travel by the travel device 25. The T/M required torque is increased and decreased in accordance with the accelerator operating amount. The controller 41 determines the T/M required torque mainly from the accelerator operating amount and the output rotation speed.

For example, the controller 41 stores first required torque data D1. The first required torque data D1 defines the relationship of a target tractive force (Ft) of the work machine 1 with respect to the output rotation speed (V) and the accelerator operating amount (A1). The controller 41 refers to the first required torque data D1 and determines the target tractive force (Ft) from the output rotation speed (V) and the accelerator operating amount (A1). The controller 41 converts the target tractive force (Ft) to the T/M required torque.

In step S102, the controller 41 determines the required torque (referred to below as W/I required torque) of the work implement 3. The W/I required torque is the output torque of the engine 21 required for causing the work implement 3 to move. The W/I required torque is increased and decreased in accordance with the work implement operating amount. The controller 41 determines the W/I required torque from the work implement operating amount and the discharge pressure of the hydraulic pump 32. For example, the controller 41 stores second required torque data D2. The second required torque data D2 defines the relationship between the work implement operating amount (A2) and the required flow rate (Qm) of hydraulic fluid. The controller 41 determines the required flow rate (Qm) of hydraulic fluid from the work implement operating amount (A2). The controller 41 calculates the W/I required torque from the required flow rate (Qm) and the discharge pressure of the hydraulic pump 32.

In step S103, the controller 41 determines a target output torque of the engine 21. The controller 41 determines the target output torque of the engine 21 from the T/M required torque and the W/I required torque. For example, the controller 41 determines the target output torque of the engine 21 from the sum of the T/M required torque and the W/I required torque.

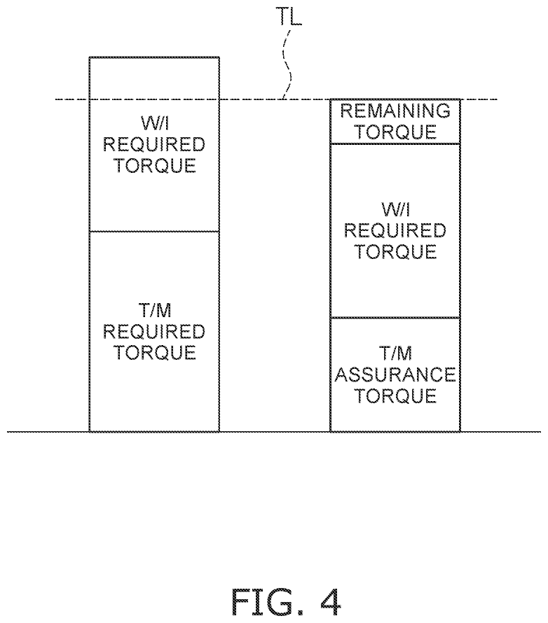

Specifically, as illustrated in FIG. 4, the controller 41 stores an upper limit TL of the target output torque. The upper limit TL of the target output torque is set in accordance with the engine rotation speed. The controller 41 determines the sum of the W/I required torque and the T/M required torque as the target output torque when the sum of the W/I required torque and the T/M required torque is equal to or less than the upper limit TL of the target output torque. The controller 41 determines the upper limit TL of the target output torque as the target output torque when the sum of the W/I required torque and the T/M required torque is greater than the upper limit TL of the target output torque.

The controller 41 determines a throttle instruction for the fuel injection device 30 in accordance with the target output torque determined as described above. Consequently, the output of the engine 21 is controlled to that the target output torque is attained.

When the sum of the W/I required torque and the T/M required torque is greater than the upper limit TL, the controller 41 corrects the T/M required torque and the W/I required torque by distributing torque to the T/M required torque and the W/I required torque in accordance with a predetermined priority level.

For example, as illustrated in FIG. 4, the controller 41 stores a T/M assurance torque. The priority level is set in order of the “T/M assurance torque,” the “W/I required torque,” and a “remaining torque” obtained by subtracting the T/M assurance torque from the T/M required torque. The priority level of the T/M assurance torque is the highest and the priority level of the remaining torque is the lowest.

The controller 41 calculates the remaining torque so that the total of the T/M assurance torque, the W/I required torque, and the remaining torque becomes the upper limit TL of the target output torque. The controller 41 determines the total of the T/M assurance torque and the remaining torque as the corrected T/M required torque. When the total of the T/M assurance torque and the W/I required torque is greater than the upper limit TL of the target output torque, the controller 41 corrects the W/I required torque so that the total of the T/M assurance torque and the W/I required torque becomes the upper limit TL of the target output torque. The controller 41 controls the capacity of the hydraulic pump 32 based on the corrected W/I required torque.

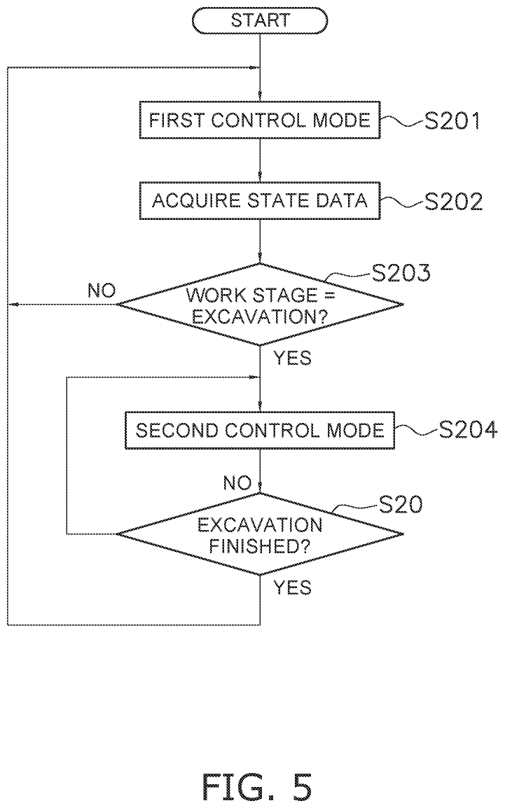

In the work machine 1 according to the present embodiment, the controller 41 executes an output limiting control for limiting the output of the engine 21 in accordance with the work stage performed by the work machine 1. The output limiting control will be explained below. FIG. 5 is a flow chart illustrating a process of the output limiting control.

As illustrated in FIG. 5, in step S201, the controller 41 controls the output of the engine 21 in a first control mode. The controller 41 controls the output of the engine 21 in the first control mode when performing predetermined work other than excavation. The controller 41 sets the upper limit of the output of the engine 21 to a first upper limit output in the first control mode. The controller 41 converts the first upper limit output of the output of the engine 21 to the output torque of the engine 21 thereby determining the abovementioned upper limit TL of the target output torque.

The predetermined work other than excavation includes, for example, loaded travel, unloaded travel, and soil unloading. The unloaded travel is work of traveling while a load is being carried on the bucket 12. The loaded travel is work of traveling while no load is being carried on the bucket 12. The soil unloading is work for unloading the load from the bucket 12.

In step S202, the controller 41 acquires state data. The state data indicates operating states of the work machine 1. The state data includes, for example, the abovementioned operating position of the FR operating member 42, the boom bottom pressure, and the boom angle.

In step S203, the controller determines the work stage of the work implement based on the operating state of the work machine 1. The controller 41 determines whether the work stage is excavation based on the state data. The controller 41 determines that the work stage is excavation when the state data satisfies a condition indicating excavation work. The condition indicating excavation work is, for example, the FR operating member 42 being in the forward travel position, the boom angle being at a predetermined angle threshold or less, and the boom bottom pressure being at a predetermined pressure threshold or more. When the work stage is predetermined work other than excavation, the first control mode is maintained in step S201.

When the work stage is excavation, the process advances to step S204. In step S204, the controller 41 controls the output of the engine 21 in the second control mode. The controller 41 reduces the upper limit of the output of the engine 21 in the second control mode to be lower than that of the first control mode. The controller 41 sets the upper limit of the output of the engine 21 to a second upper limit output in the second control mode. The second upper limit output is smaller than the first upper limit output.

The second upper limit output is set as an output of the engine 21 that is sufficient when performing excavation with the work machine 1. The second upper limit output may be a constant value. Alternatively, the second upper limit output may be variable. The second upper limit output may be manually set by an operator using the input device 45. The controller 41 converts the second upper limit output of the output of the engine 21 to the output torque of the engine 21 thereby determining the abovementioned upper limit TL of the target output torque.

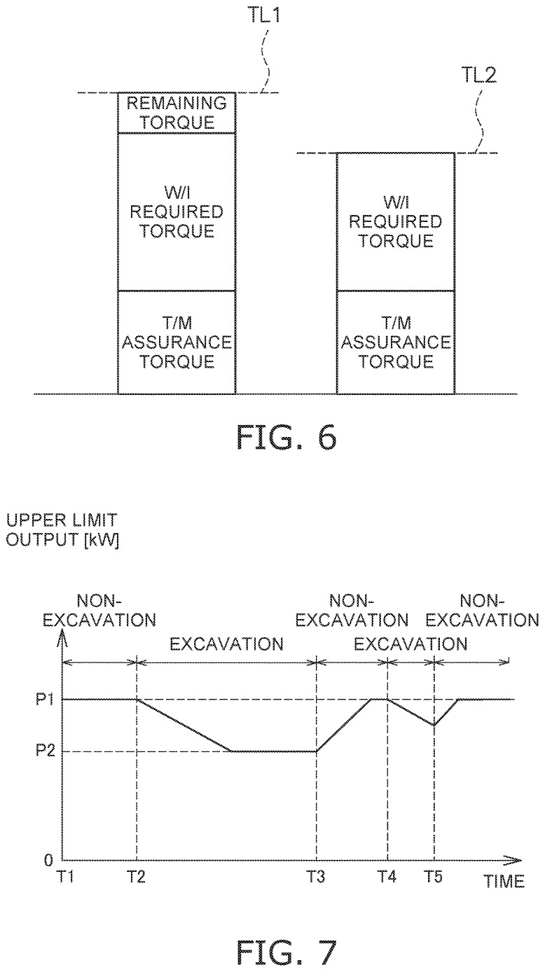

FIG. 6 illustrates a first torque upper limit TL1 and a second torque upper limit TL2 of the target output torque. The first torque upper limit TL1 indicates the upper limit TL of the target output torque calculated from the first upper limit output in the first control mode. The second torque upper limit TL2 indicates the upper limit TL of the target output torque calculated from the second upper limit output in the second control mode. As illustrated in FIG. 6, the second torque upper limit TL2 is less than the first torque upper limit TL1. Therefore, the controller 41 reduces the upper limit TL of the target output torque from the first torque upper limit TL1 to the second torque upper limit TL2 in the second control mode.

In step S205, the controller 41 determines whether the excavation is finished. The controller 41 determines that the excavation is finished when, for example, the abovementioned condition indicating excavation work is not satisfied. When the excavation is finished, the controller 41 controls the output of the engine 21 in the first control mode in step S201. That is, the controller 41 increases the upper limit of the output of the engine 21 from the second upper limit output to the first upper limit output. If the excavation is not finished, the second control mode is maintained in step S204.

FIG. 7 is a timing chart illustrating the upper limits of the output of the engine 21 modified in accordance with the work stage. “Non-excavation” in FIG. 7 signifies predetermined work other than excavation. As illustrated in FIG. 7, the work machine 1 performs non-excavation work from time T1 to T2. In this case, the controller 41 controls the output of the engine 21 in the first control mode and sets the upper limit of the output of the engine 21 to the first upper limit output P1.

When the work is switched from non-excavation to excavation at the time T2, the controller 41 switches the control mode of the engine 21 from the first control mode to the second control mode. Consequently, the controller 41 reduces the upper limit of the output of the engine 21 from the first upper limit output P1 to the second upper limit output P2. At this time, the controller 41 reduces the upper limit of the output of the engine 21 at a predetermined reduction rate. The predetermined reduction rate signifies the amount of reduction of the upper limit output per unit of time. Consequently, the upper limit of the output of the engine 21 is reduced gradually from the time T2 from the first upper limit output P1 to the second upper limit output P2.

When the work is switched from excavation to non-excavation at the time T3, the controller 41 switches the control mode of the engine 21 from the second control mode to the first control mode. Consequently, the controller 41 increases the upper limit of the output of the engine 21 from the second upper limit output P2 to the first upper limit output P1. At this time, the controller 41 increases the upper limit of the output of the engine 21 at a predetermined increase rate. The predetermined increase rate signifies the amount of increase of the upper limit output per unit of time. Consequently, the upper limit of the output of the engine 21 is increased gradually from the time T3 from the second upper limit output P2 to the first upper limit output P1.

Similarly, when the work is switched from non-excavation to excavation at the time T4, the controller 41 switches the control mode of the engine 21 from the first control mode to the second control mode. Consequently, the controller 41 reduces the upper limit of the output of the engine 21 from the first upper limit output P1. When the work is switched from excavation to non-excavation at the time T5, the controller 41 switches the control mode of the engine 21 from the second control mode to the first control mode. Consequently, the controller 41 increases the upper limit of the output of the engine 21 to the first upper limit output P1.

The absolute value of the predetermined reduction rate is less than the absolute value of the predetermined increase rate. Therefore, when the upper limit of the output of the engine 21 is reduced, the upper limit of the output of the engine 21 changes more slowly than when increasing the upper limit of the output of the engine 21. In other words, when the upper limit of the output of the engine 21 is increased, the upper limit of the output of the engine 21 changes more quickly than when reducing the upper limit of the output of the engine 21.

In the work machine 1 according to the present embodiment described above, when the work stage is determined as being excavation, the output of the engine 21 is controlled in the second control mode. In the second control mode, the upper limit of the output of the engine 21 is reduced more than in the first control mode. The first upper limit output in the first control mode is greater than the output of the engine 21 necessary for excavation, and the second upper limit output in the second control mode is the output of the engine 21 sufficient for excavation. As a result, fuel consumption is improved because the engine 21 is controlled in the second control mode at a suitable output that corresponds to the load on the work machine 1 during excavation.

Although an embodiment of the present invention has been described so far, the present invention is not limited to the above embodiment and various modifications may be made within the scope of the invention.

The work machine 1 is not limited to a wheel loader and may be another machine such as a bulldozer or a motor grader. The work machine 1 may be remotely operated. In this case, the FR operating member 42, the accelerator operating member 43, the work implement operating member 44, and the input device 45 may be disposed outside the work machine 1.

The controller 41 may be configured by a plurality of controllers. The abovementioned processing of the control of the work machine 1 may distributed and executed among the plurality of controllers. The control method of the engine 21 is not limited to that of the above embodiment and may be modified. The abovementioned correction of the W/I required torque and the correction of the T/M required torque may be omitted.

The output limiting control of the engine 21 is not limited to that of the above embodiment and may be modified. The method for determining whether the work stage is excavation is not limited to that of the above embodiment and may be modified. For example, the work stage may be determined with an image captured by a camera.

For example, the controller 41 may control the output of the engine 21 in the second control mode during work other than excavation. For example, the controller 41 may control the output of the engine 21 in the second control mode when the work machine 1 is performing hill climbing travel. The controller 41 may determine whether the work stage is hill climbing travel from the output rotation speed and the attitude of the vehicle body 2. Alternatively, the controller 41 may control the output of the engine 21 in the first control mode when the work machine 1 is performing hill climbing travel.

The control mode for the maximum tractive force of the work machine 1 may be set manually. For example, the control mode of the maximum tractive force may include a Hi-mode and a Lo-mode. The controller 41 may control the engine 21 so that the maximum tractive force of the work machine 1 is lower in the Lo-mode than in the Hi-mode. The abovementioned output limiting control may be executed only when the Hi-mode is selected. Alternatively, the output limiting control may be executed when any one of the Hi-mode and the Lo-mode is selected.

According to the present disclosure, fuel consumption can be improved in a work machine by controlling the engine with a suitable output in accordance with the load on the work machine.

1. A work machine comprising:
a vehicle body;
an engine mounted to the vehicle body;
a travel device that is mounted to the vehicle body and causes the vehicle body to travel by being driven with driving power from the engine;
a work implement that is movably supported by the vehicle body and operates with the driving power from the engine;
a sensor that detects state data indicating operating states of the travel device and the work implement; and
a controller to control the engine, the travel device, and the work implement, the controller being configured to
acquire the state data,
determine a work stage being performed by the work machine based on the operating states of the travel device and the work implement,
control an output of the engine in a first control mode when the work stage is determined as being predetermined work other than excavation,
control the output of the engine in a second control mode when the work stage is determined as being excavation, and
reduce the output of the engine in the second control mode to be lower than in the first control mode.

2. The work machine according to claim 1, wherein
the controller is configured to reduce an upper limit of the output of the engine gradually at a predetermined reduction rate when switching from the first control mode to the second control mode.

3. The work machine according to claim 1, wherein
the controller is configured to increase an upper limit of the output of the engine gradually at a predetermined increase rate when switching from the second control mode to the first control mode.

4. The work machine according to claim 1, wherein
the controller is configured to
reduce an upper limit of the output of the engine gradually at a predetermined reduction rate when switching from the first control mode to the second control mode, and
increase the upper limit of the output of the engine gradually at a predetermined increase rate when switching from the second control mode to the first control mode, and
an absolute value of the predetermined reduction rate is less than an absolute value of the predetermined increase rate.

5. A method for controlling a work machine including a vehicle body, an engine mounted to the vehicle body, a travel device that is mounted to the vehicle body and causes the vehicle body to travel by being driven with driving power from the engine, and a work implement movably supported by the vehicle body and operating with the driving power from the engine, the method comprising:
detecting state data indicating operating states of the travel device and the work implement;
determining a work stage being performed by the work machine based on the operating states of the travel device and the work implement;
controlling an output of the engine in a first control mode when the work stage is determined as being predetermined work other than excavation;
controlling the output of the engine in a second control mode when the work stage is determined as being excavation; and
reducing the output of the engine in the second control mode to be lower than the that of the first control mode.

6. The method according to claim 5, further comprising:
reducing an upper limit of the output of the engine gradually at a predetermined reduction rate when switching from the first control mode to the second control mode.

7. The method according to claim 5, further comprising:
increasing an upper limit of the output of the engine gradually at a predetermined increase rate when switching from the second control mode to the first control mode.

8. The method according to claim 5, further comprising:
reducing an upper limit of the output of the engine gradually at a predetermined reduction rate when switching from the first control mode to the second control mode; and
increasing the upper limit of the output of the engine gradually at a predetermined increase rate when switching from the second control mode to the first control mode,
an absolute value of the predetermined reduction rate being less than an absolute value of the predetermined increase rate.
